(19) United States
(12) Patent Application Publication
(10) Pub. No.: US 2010/0175113 A1
(43) Pub. Date: Jul. 8, 2010

(54) Secure System Access Without Password Sharing

(75) Inventors: Stefano Borghetti, Viterbo (IT); Gianluca della Corte, Napoli (IT); Leonida Gianfagna, Rome (IT); Alessandro Haag, Montesilvano (IT); Antonio Sgro, Girifalco (IT)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machine Corporation, Armonk, NY (US)

(21) Appl. No.: 12/348,389

(22) Filed: Jan. 5, 2009

(51) Int. Cl. H04L 29/06

(52) U.S. Cl. 726/5

(57) ABSTRACT

A mechanism is provided for performing secure system access by a requesting user without sharing a password of a credential owner. A database stores system information for resources. The owner of super user authority for a resource provides system information to the database including a credential for accessing the resource. When a user wishes to access the system, client software of the requestor sends an access request to client software of the owner. The client software of the owner prompts the owner to authorize or deny access. Responsive to the owner authorizing the access, the client software of the owner returns authorization to the client software of the requestor, which then uses the credential in the system information database to access the resource. The client software of the requestor does not cache or store the credential or present the credential to the user.

### BACKGROUND

The present application relates generally to an improved data processing apparatus and method and more specifically to an apparatus for performing secure system access by a requesting user without sharing a password of a credential owner.

Companies assign systems, or more generally resources, to one or more employees for work and/or management purposes. A company may assign a super user authority for a resource to one owner. The super user, or owner, may hold a credential that authorizes the owner to access the resource. A common credential comprises a user name and password. User names may be private or public; however, the password, in most cases, should be secret and known only by the super user authority owner.

When needed, a user other than the owner may require access to a resource. If the owner is in close proximity to the user, the owner may enter the user name and password to allow the user access to the resource. Alternatively, the owner of the super user authority may share the password with the user to allow access.

In some contexts, such as software development, a user may need to use the resource sporadically. The owner may not always be present to allow the user access; therefore, password sharing may become a frequent occurrence. In this context, the integrity of password is compromised, and the owner must frequently change the password. This creates a burden on the owner to keep track of an ever-changing password and to protect the secrecy of the password in a demanding environment.

### SUMMARY

In one illustrative embodiment, a method, in a data processing system, is provided for performing secure system access. The method comprises identifying an entry for a shared system in a system information database. The entry comprises an identifier of a host, a protocol, an identifier of an owner, and a credential. The method further comprises sending an access request to a client associated with the owner and responsive to the owner authorizing access to the shared system by the requesting user, opening a session with the host using the protocol and the credential.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIG. 3 is a diagram depicting secure system access without password sharing in accordance with an illustrative embodiment;

FIG. 4 is a flowchart outlining example operations of an owner client for secure system access without password sharing in accordance with an illustrative embodiment; and

FIG. 5 is a flowchart outlining example operations of a requestor client for secure system access without password sharing in accordance with an illustrative embodiment.

### DETAILED DESCRIPTION

The illustrative embodiments provide a mechanism for performing secure system access by a requesting user without sharing a password of a credential owner. A database stores system information for resources. The owner of super user authority for a resource provides system information to the database including a credential for accessing the resource. When a user wishes to access the system, client software of the requestor sends an access request to client software of the owner. The client software of the owner prompts the owner to authorize or deny access. Responsive to the owner authorizing the access, the client software of the owner returns authorization to the client software of the requestor, which then uses the credential in the system information database to access the resource. The client software of the requestor does not cache or store the credential or present the credential to the user.

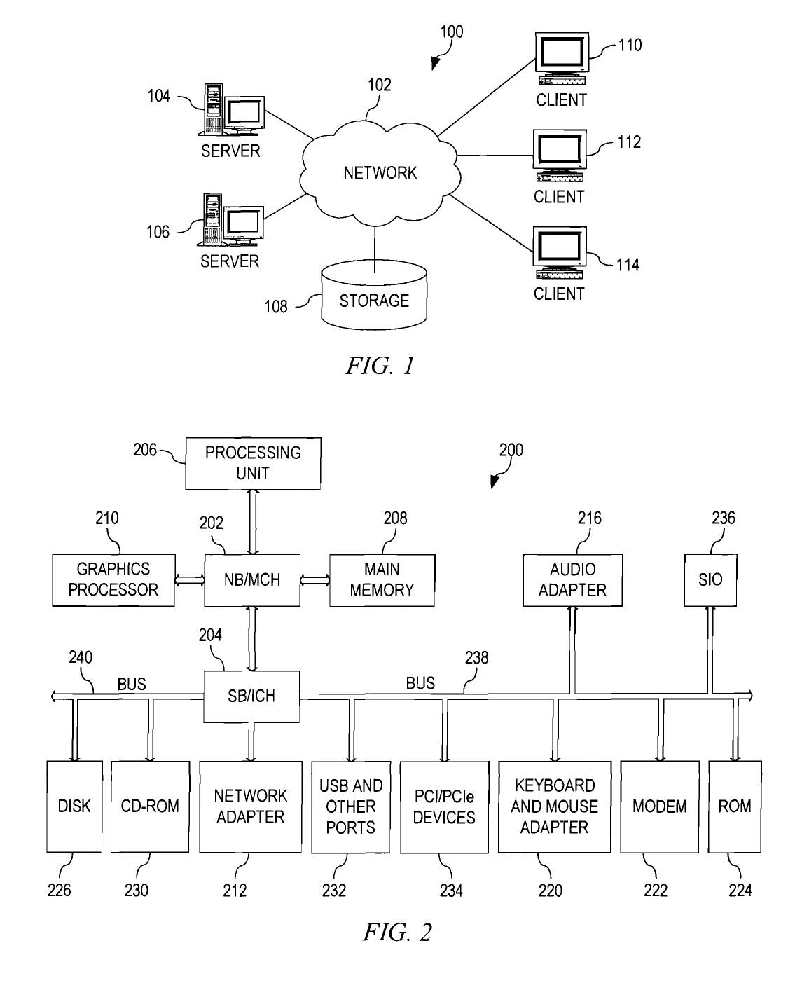

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on distributed data processing environments, this is only an example and is not intended to state or imply any limitation with regard to the features of the present invention. To the contrary, the illustrative embodiments are intended to also include a single data processing device implementation.

With reference now to the figures and in particular with reference to FIGS. 1 and 2, example diagrams of data processing environments are provided in which illustrative embodiments of the present invention may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

Server 104, for example, may control access to a resource, such as a database within storage 108, a hardware resource, or a software resource on server 104. A user at client 110, for example, may be an owner of super user authority for the resource. A user at client 112, for example, may wish to access the resource. Thus, to permit access, the owner at client 110 may either move to client 112 to enter the credential or share the credential with the user at client 112.

In accordance with an illustrative embodiment, the owner may register the resource as a system within a system information database by storing system information including a credential for accessing the resource. The system information database may be stored within storage 108, for example. Client software at client 112 may send a request to the owner at client 110. Client software at client 110 may then prompt the owner to authorize or deny access to the resource. If the owner authorizes access, client 110 sends authorization to client 112. Client software at client 112 may then use the credential from the system information database to access the resource without storing, caching, or externally presenting the credential.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

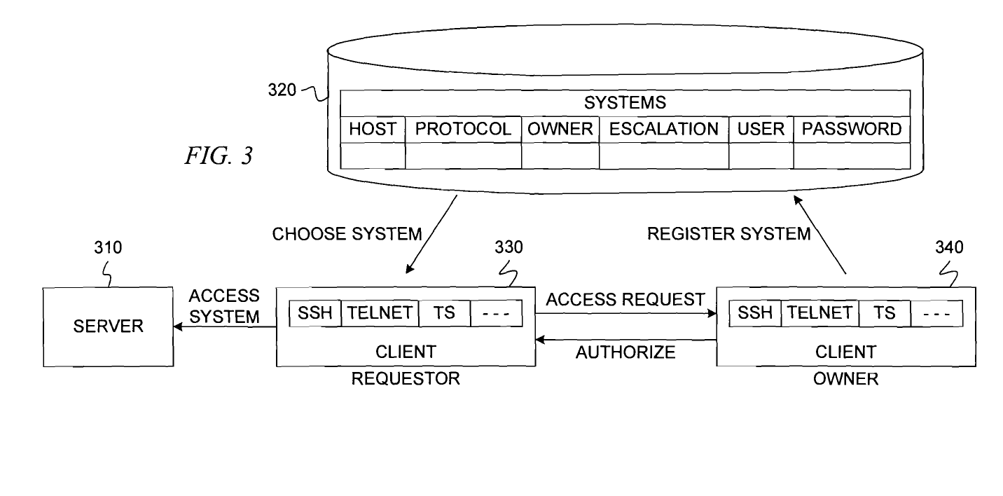

FIG. 3 is a diagram depicting secure system access without password sharing in accordance with an illustrative embodiment. Requestor client 330 and owner client 340 comprises a plurality of communications protocols, such as Secure Shell (SSH), Telnet, Terminal Services (TS), and the like. Client 330 and client 340 may comprise devoted client software on a client computer that is able to implement different system access mechanisms. Client 330 and client 340 may be active and interact with the user during the process of browsing shared systems, requesting access to shared systems, and granting or denying access to shared systems. In one example embodiment, client 330 and client 340 may be embedded in a corporate messaging tool, such as Sametime®. “SAMETIME” is a trademark of International Business Machines Corporation in the United States, other countries, or both.

Owner client 340 registers a system or resource by storing system information in database 320. The system information may include, for example, a host identifier, a protocol for accessing the host, and a credential for accessing the system. The credential may comprise a user name and password, for example. In addition, the system information may include an owner identifier to be used by the requestor client to send an access request.

A requestor at client 330 may browse the systems in system information database 320. The systems may include databases, server applications, and the like. When the requestor identifies a shared system to which she requires access, requestor client 330 sends an access request to owner client 340. The access request may include a business need (the reason the user wishes to access the system). This is very useful information in access tracking. Client 340 then prompts the owner to authorize or deny access to the requestor. Responsive to the owner authorizing the access, client 340 returns an authorize notification or message to client 330. If the owner denies access, client 340 returns a deny notification to client 330.

Responsive to receiving an authorize notification, client 330 uses the host ID, protocol, and credential to access the system at server 310. Server 310 may comprise devoted server software on a server computer that is able to communicate with the clients. Server 310 may provide the shared systems browsing feature and shared system credentials to clients 330, 340. Client 330 opens a session with server 310 without caching or storing the credential or presenting the credential externally. That is, using a user name and password to open a session is transparent to the requesting user.

In one example embodiment, the system information database 320 includes an escalation list of people who can be prompted for authorization when the owner is unavailable. The escalation list may include another owner, a team leader, a manager, a second line manager, and so forth. Thus, when client 340 fails to result in an authorization or denial within a predetermined time period, the access request may be forwarded by client 340, or re-sent by client 330, to the next person in the escalation list.

In another example embodiment, the shared system information database 320 does not store the password. When a user requests access to the system, server 310 may access and create a dummy user with the required authorities for the shared system, such as root, db2adm, etc. Server 310 then deletes the dummy user when access by the requesting user is no longer needed.

In a further embodiment, the shared system owner may set a time window in which the authorized requesting user may use the shared system. Client 340 may communicate this time window to server 310. At the end of the time window, server 310 may log the user out of the system automatically. Server 310 may apply this time window to the user at client 330 using the owner credentials or may apply the time window to a dummy user created for the requesting user.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

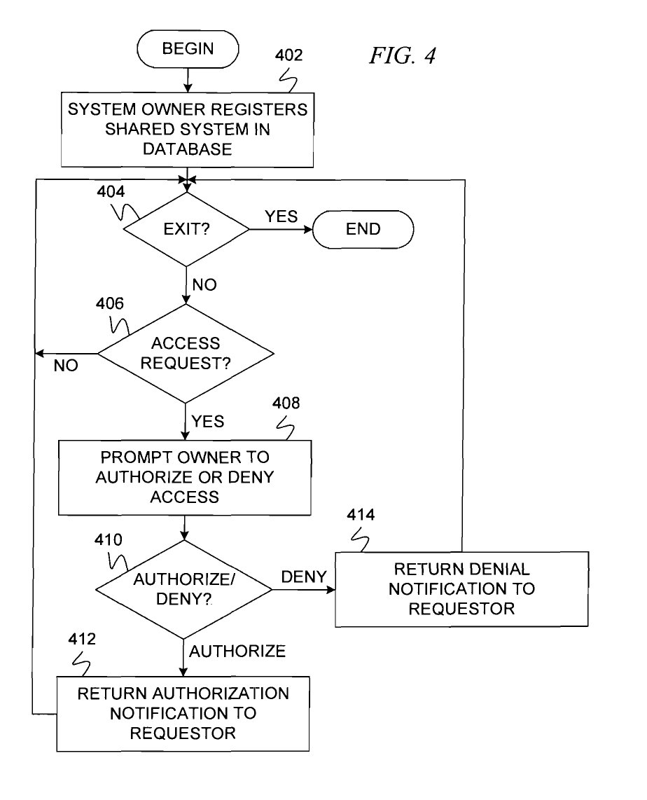

FIG. 4 is a flowchart outlining example operations of an owner client for secure system access without password sharing in accordance with an illustrative embodiment. Operation begins, and the system owner registers the shared system in the system information database (block 402). The owner client determines whether an exit condition exists (block 404). An exit condition may exist if the owner client shuts down or the owner ceases sharing the system, for example. If an exit condition exists, operation ends.

If an exit condition does not exist in block 404, the owner client determines whether an access request is received (block 406). If an access request is not received, operation returns to block 404 to determine whether an exit condition exists. If the owner client receives an access request in block 406, the owner client prompts the owner to authorize or deny access by the requestor to the shared system (block 408). The owner client then determines whether the owner authorizes or denies access to the shared system by the requestor (block 410).

If the owner authorizes access to the shared system, the owner client returns an authorization notification to the requesting client (block 412). Operation then returns to block 404 to determine whether an exit condition exists. If the owner denies access to the shared system in block 410, the owner client returns a denial notification to the requestor (block 414), and operation returns to block 404 to determine whether an exit condition exists.

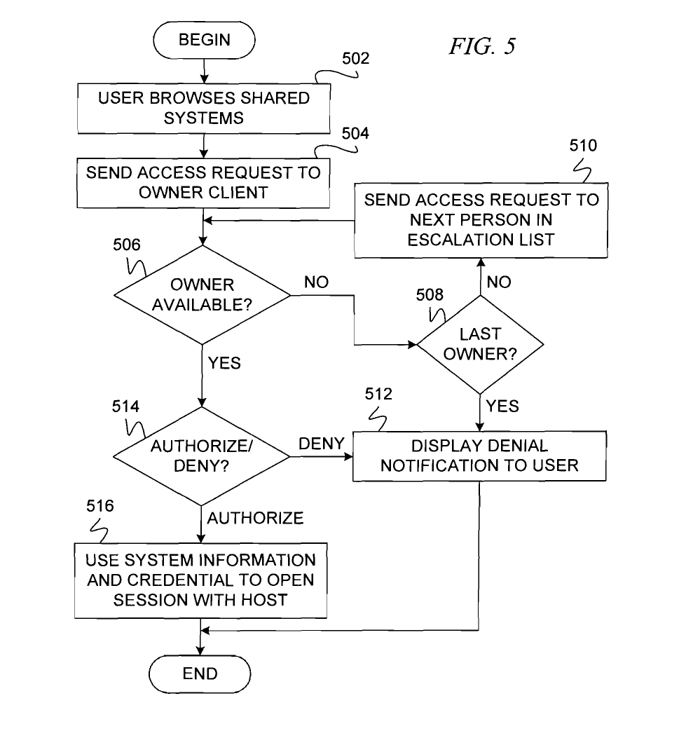

FIG. 5 is a flowchart outlining example operations of a requestor client for secure system access without password sharing in accordance with an illustrative embodiment. Operation begins, and the user browses shared systems registered in the system information database (block 502). When the user browses shared systems, the requestor client keeps credential information, such as user name and password, secret. When the user finds a shared system that the user wishes to access, the requestor client sends an access request to the owner client (block 504).

Then, the requestor client determines whether the owner is available (block 506). The requestor client may make this determination by determining whether the owner client returns an unavailable notification or by using a timeout mechanism. If the owner is not available, the requestor client determines whether the owner to which the access request was sent is the last owner in an escalation list of users authorized to grant access to the shared resource (block 508). For instance, the owner of super user authorization may grant permission to a subset of other users to grant access to a shared resource. The owner may then list those users in an escalation list in the system information database. These users may include a team leader, manager, second line manager, or the like.

If the owner is not the last user authorized to grant access to the shared resource in block 508, the requestor client sends the access request to the next person in the escalation list (block 510), and operation returns to block 506 to determine whether the next person (owner) is available. If the current owner is the last owner in the escalation list in block 508, the requestor client displays a denial notification to the requesting user (block 512), and operation ends.

If the owner is available in block 506, the requestor client determines whether the owner client returns an authorization notification or a denial notification (block 514). If the owner client returns a denial notification, operation proceeds to block 512 to display a denial notification to the user. Thereafter, operation ends. If the requestor client determines that the owner client returns an authorization notification in block 514, then the requestor client uses the system information and credential to open a session with the host (block 516). Thereafter, operation ends.

Thus, the illustrative embodiments provide mechanisms for performing secure system access by a requesting user without sharing a password of a credential owner. A database stores system information for resources. The owner of super user authority for a resource provides system information to the database including a credential for accessing the resource. When a user wishes to access the system, client software of the requestor sends an access request to client software of the owner. The client software of the owner prompts the owner to authorize or deny access. Responsive to the owner authorizing the access, the client software of the owner returns authorization to the client software of the requestor, which then uses the credential in the system information database to access the resource. The client software of the requestor does not cache or store the credential or present the credential to the user. Thus, there is no password sharing. Access is controlled on a session-by-session basis with the possibility to trace every access. Furthermore, the owner is not required to be physically located in close proximity to the requesting user to provide the access to the shared system or resource.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable odems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a client associated with a requesting user, for performing secure system access, the method comprising:
identifying an entry for a shared system in a system information database, wherein the entry comprises an identifier of a host, a protocol, an identifier of an owner, and a credential;
sending an access request to a client associated with the owner; and
responsive to the owner authorizing access to the shared system by the requesting user, opening a session with the host using the protocol and the credential.

2. The method of claim 1, wherein the client associated with the requesting user does not present the credential to the requesting user.

3. The method of claim 1, wherein the client associated with the requesting user does not store or cache the credential.

4. The method of claim 1, wherein the credential comprises a user name and password.

5. The method of claim 1, wherein the entry further comprises an escalation list of users authorized to grant access to the shared system.

6. The method of claim 5, further comprising:
responsive to the owner not being available, sending an access request to a client associated with a next user in the escalation list.

7. The method of claim 1, wherein the client associated with the owner prompts the owner to authorize or deny access to the shared system by the requesting user.

8. The method of claim 1, wherein the owner registers the shared system by creating the entry in the system information database.

9. A computer program product comprising a computer recordable medium having a computer readable program recorded thereon, wherein the computer readable program, when executed on a computing device, causes the computing device to:
identify an entry for a shared system in a system information database, wherein the entry comprises an identifier of a host, a protocol, an identifier of an owner, and a credential;
send an access request to a client associated with the owner; and
responsive to the owner authorizing access to the shared system by the requesting user, open a session with the host using the protocol and the credential.

10. The computer program product of claim 9, wherein the client associated with the requesting user does not present the credential to the requesting user.

11. The computer program product of claim 9, wherein the client associated with the requesting user does not store or cache the credential.

12. The computer program product of claim 9, wherein the credential comprises a user name and password.

13. The computer program product of claim 9, wherein the entry further comprises an escalation list of users authorized to grant access to the shared system.

14. The computer program product of claim 13, further comprising:
responsive to the owner not being available, sending an access request to a client associated with a next user in the escalation list.

15. The computer program product of claim 9, wherein the client associated with the owner prompts the owner to authorize or deny access to the shared system by the requesting user.

16. The computer program product of claim 9, wherein the owner registers the shared system by creating the entry in the system information database.

17. An apparatus, comprising:
a processor; and
a memory coupled to the processor, wherein the memory comprises instructions which, when executed by the processor, cause the processor to:
identifying an entry for a shared system in a system information database, wherein the entry comprises an identifier of a host, a protocol, an identifier of an owner, and a credential;
sending an access request to a client associated with the owner; and
responsive to the owner authorizing access to the shared system by the requesting user, opening a session with the host using the protocol and the credential.

18. The apparatus of claim 17, wherein the client associated with the requesting user does not present the credential to the requesting user and wherein the client associated with the requesting user does not store or cache the credential.

19. The apparatus of claim 17, wherein the credential comprises a user name and password.

20. The apparatus of claim 17, wherein the entry further comprises an escalation list of users authorized to grant access to the shared system.
